(19) United States
(12) Patent Application Publication
(10) Pub. No.: US 2014/0123071 A1
(43) Pub. Date: May 1, 2014

(54) Multi-directionally rotating portal

(71) Applicant: Rightware Oy, Espoo (FI)

(72) Inventor: Arto Ruotsalainen, Espoo (FI)

(73) Assignee: Rightware Oy, Espoo (FI)

(21) Appl. No.: 14/037,421

(22) Filed: Sep. 26, 2013

Related U.S. Application Data
(60) Provisional application No. 61/722,828, filed on Nov. 6, 2012.

(30) Foreign Application Priority Data
Oct. 31, 2012 (EP) 12190840.4

(51) Int. Cl. G06F 3/0481; G06F 3/0484

(52) U.S. Cl. CPC G06F 3/04815; G06F 3/04817; G06F 3/04842
USPC 715/836

(57) ABSTRACT

A method of generating and populating a three-dimensional rotatable user interaction portal is provided, comprising the steps of determining or retrieving a plurality categories, determining or retrieving a plurality of selectable list items associated with each list category, generating a three-dimensional body that can rotate about a first axis, the three-dimensional body in turn comprising a plurality of three-dimensional body components, each body component being rotatable about a second axis, arranging and displaying the selectable list items in the plurality of three-dimensional body components, and allowing a user, through a user input means, to rotate the three-dimensional body and/or one or more of the three-dimensional body components, along a defined path provided by the first and/or second axis, respectively.

### FIELD OF THE INVENTION

This invention relates to a method of and system for displaying in 3D a plurality of lists and facilitating user interaction with items within the lists.

### BACKGROUND TO THE INVENTION

The explosion of selectable options or items on state of the art devices, such as tablets, cellular telephones, TVs and other hardware devices over the last decade has been overwhelming. Even though these selectable items are typically categorized into, for example, videos, games, music, advertisements, apps etc., the number of selectable items within each list category and the number of categories themselves are continuously increasing.

Typical items listing arrangements do not cater for this current landscape of ever increasing categories and selectable items within each list category.

The aim of the present invention is thus to provide a 3D multi-directional rotating portal that displays list categories and list items within each category to a user in an intuitive and easily interactive manner, for subsequent interaction by the user.

### SUMMARY OF THE INVENTION

According to a first aspect of the invention there is provided a method of generating and populating a three-dimensional rotatable user interaction portal comprising the steps of;
determining or retrieving a plurality of list categories;
determining or retrieving a plurality of selectable list items associated with each list category;
generating a three-dimensional body that can rotate about a first axis, the three-dimensional body in turn comprising a plurality of three-dimensional body components, each body component being rotatable about a second axis;
arranging and displaying the selectable list items in the plurality of three-dimensional body components; and
allowing a user, through a user input means, to rotate the three-dimensional body and/or one or more of the three-dimensional body components, along a defined path provided by the first and/or second axis, respectively.

In an embodiment, each list category is associated with one of the three-dimensional body components, with the category being optionally displayed proximate the relevant body component.

In an embodiment, each of the three-dimensional body components comprises a plurality of selectable list items that may be selected by the user.

In an embodiment, the first and second axes extend perpendicular to each other e.g. the first axis may extend horizontally and the second axis vertically, or vice versa.

In an embodiment, the three-dimensional body and/or one or more of the three-dimensional body components may be rotated multi-directionally e.g. either clockwise or anti-clockwise.

In an embodiment, each selectable list item is either active, wherein the user can select the list item so as to trigger an external event, or passive, wherein the data element does not trigger an external event.

In an embodiment, and in respect of active list items, the method comprises the steps of allowing a user, through the user input means, to select any of the active list items, with each active list item either having a corresponding resource location that resides on either the remote server or an external server, in which case the remote server serves as a link between the user and the external server. In this embodiment, in response to the user selecting an active list item, the user is redirected to the associated resource location.

Alternatively, the selection of an active list item triggers an application on a user device, such as playing a video, a game, or a music track.

In an embodiment, and in respect of passive list items, the passive list items comprise data, including, but not limited to, images, text or other static information.

In an embodiment, the list items and/or list categories are stored offline or on a remote server.

According to a second aspect of the invention there is provided a system for generating and populating a three-dimensional rotatable user interaction portal comprising a processor that is arranged to;
determine or retrieving a plurality of list categories;
determine or retrieving a plurality of selectable list items associated with each list category;
generate a three-dimensional body that can rotate about a first axis, the three-dimensional body in turn comprising a plurality of three-dimensional body components, each body component being rotatable about a second axis;
arrange and displaying the selectable list items in the plurality of three-dimensional body components; and
allow a user, through a user input means, to rotate the three-dimensional body and/or one or more of the three-dimensional body components, along a defined path provided by the first and/or second axis, respectively.

In an embodiment, each selectable list item is either active, wherein the user can select the list item so as to trigger an external event, or passive, wherein the data element does not trigger an external event.

In an embodiment, and in respect of active data elements, the processor is arranged to allow a user, through the user input means, to select any of the active list items, with each active list item either having a corresponding resource location that resides on either the remote server or an external server, in which case the remote server serves as a link between the user and the external server. In this embodiment, in response to the user selecting an active list item, the processor redirects the user to the associated resource location.

Alternatively, the selection of an active list item triggers an application on a user device, such as playing a video, a game, or a music track.

In an embodiment, and in respect of passive list items, the passive list items comprise data, including, but not limited to, images, text or other static information.

According to a third aspect of the invention there is provided a non-transitory computer readable medium having stored thereon a set of computer readable instructions for causing a processor to generate and populate a three-dimensional rotatable user interaction portal comprising the computer implemented steps of;
determining or retrieving a plurality of list categories;
determining or retrieving a plurality of selectable list items associated with each list category;
generating a three-dimensional body that can rotate about a first axis, the three-dimensional body in turn comprising a plurality of three-dimensional body components, each body component being rotatable about a second axis;
arranging and displaying the selectable list items in the plurality of three-dimensional body components; and
allowing a user, through a user input means, to rotate the three-dimensional body and/or one or more of the three-dimensional body components, along a defined path provided by the first and/or second axis, respectively.

According to a fourth aspect of the invention there is provided a system for generating and populating a three-dimensional rotatable user interaction portal, the system comprising;
a user device associated with a user, the user device comprising a processor, a display and user input means; and
a server remote from the user device but in communication with the user device, the server comprising storage means to store selectable list items, the remote server being arranged to send list items to the user device for display on the user device display,

wherein the user processor of the user device is arranged to:
generate a three-dimensional body that can rotate about a first axis, the three-dimensional body in turn comprising a plurality of three-dimensional body components, each body component being rotatable about a second axis;
arrange and displaying the selectable list items in the plurality of three-dimensional body components; and
allow a user, through a user input means, to rotate the three-dimensional body and/or one or more of the three-dimensional body components, along a defined path provided by the first and/or second axis, respectively.

### BRIEF DESCRIPTION OF THE DRAWINGS

The invention will be described, by way of example only, with reference to the accompanying drawings in which:

FIG. 1 shows a high level schematic view of a system for generating and populating a three-dimensional rotatable user interaction portal, according to a first aspect of the present invention;

FIG. 2 shows a flowchart representing a method of generating and populating a three-dimensional rotatable user interaction portal, according to a second aspect of the present invention; and

FIG. 3 shows a user device showing the solution of the present invention in use.

### DETAILED DESCRIPTION OF PREFERRED EMBODIMENTS

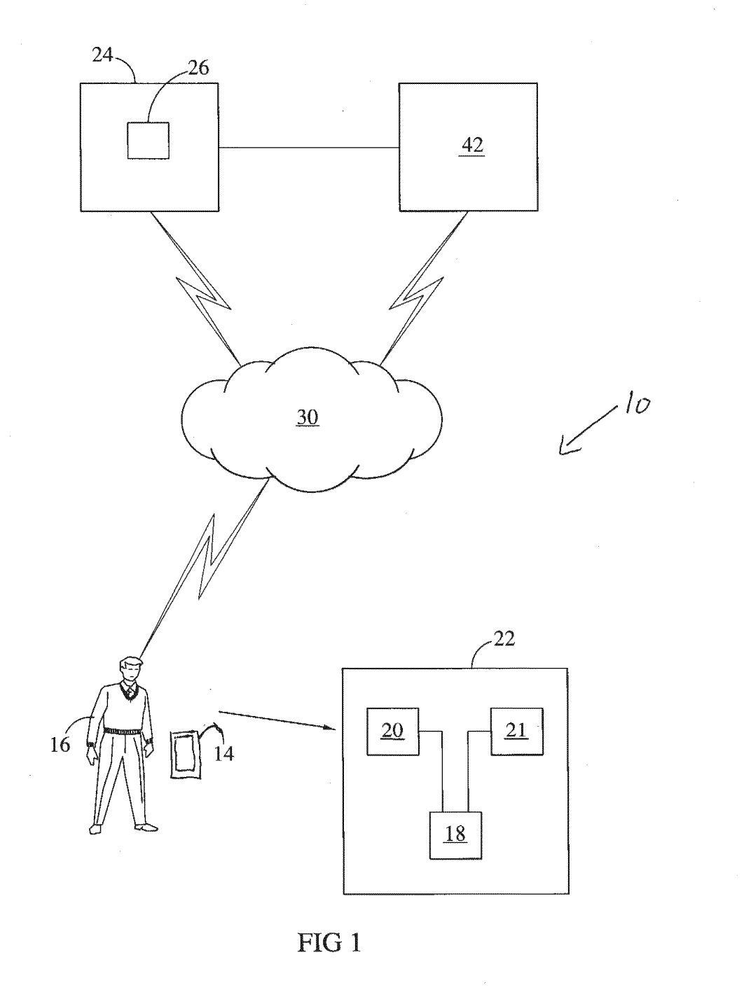

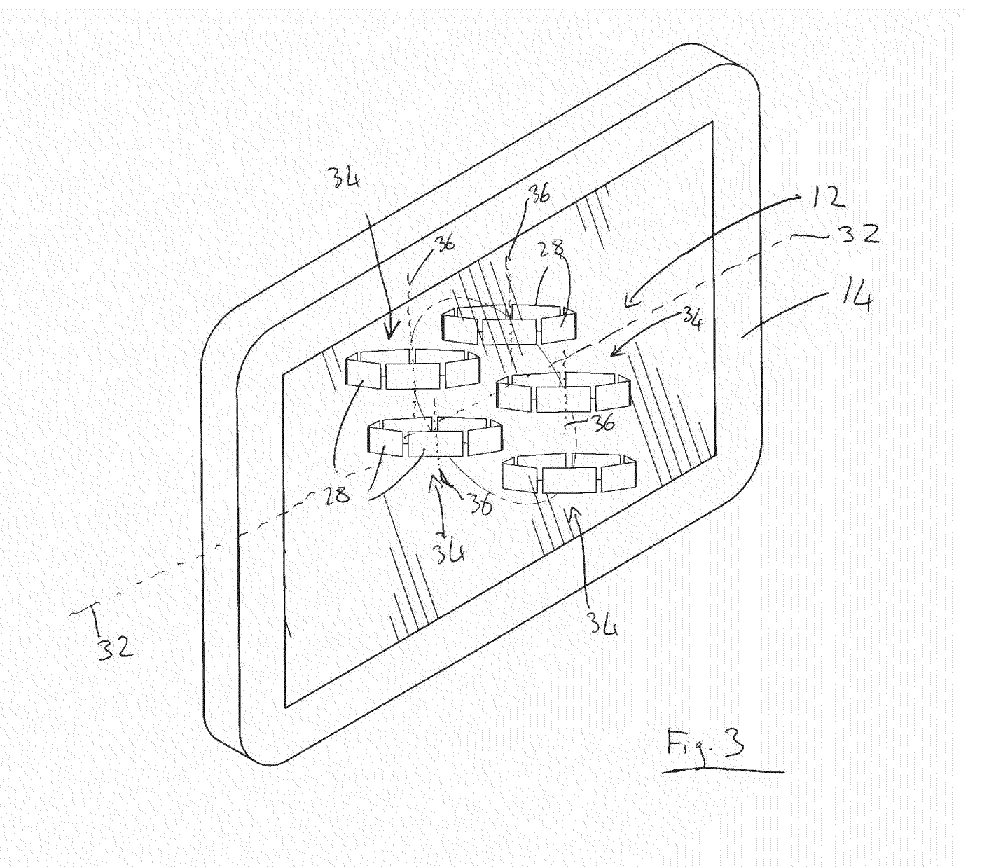

In broad terms, and with particular reference to FIG. 1, there is provided a system 10 for generating and populating a three-dimensional rotatable user interaction portal body 12, such as of the type shown in FIG. 3. The system 10 comprises a user device 14 associated with a user 16, the user device 14 comprising a processor 18, a display 20 and user input means 21, as shown in the schematic block 22.

The system 10 further comprises an online server 24 remote from the user device 14, the server 24 comprising storage means 26 to store selectable list items (indicated by reference numeral 28 in FIG. 3). As will become clearer further on in the specification, in one embodiment, the remote server 24 may be arranged to send list items 28 to the user device 14 for display on the user device display 20.

A communications network 30 is also provided to enable data, including the selectable list items 28, to be exchanged between the user device 14 and the remote server 24, which can be done in any one of a number of well known ways. Thus, for example, in the case of the user device 14 taking the form of a mobile smartphone, the network 30 may comprise a GSM cellular telephone network.

In use, and with reference now also to FIG. 3, the processor 18 of the user device 14 is arranged to determine or retrieve a plurality of list categories, and to determine or retrieve a plurality of selectable list items associated with each list category. Thereafter, the processor 18 generates the three-dimensional portal body 12 that can rotate about a first axis 32. The three-dimensional portal body 12 in turn comprises a plurality of three-dimensional body components 34, each body component being rotatable about a second axis 36.

Each of the three-dimensional body components 34 comprises a plurality of selectable list items 28 that may be selected by the user. Thus, the sides of the of the three-dimensional body components 34 represent pages that may be flipped or rotated, as will be explained in more detail further below. In particular, the user may rotate the three-dimensional body and/or one or more of the three-dimensional body components, along a defined (circular, in an embodiment and as illustrated) path provided by the first axis 32 and/or second axis 36, respectively.

In an embodiment, each list category is associated with one of the three-dimensional body components 34, with the category being optionally displayed proximate the relevant body component 34.

In an embodiment, the first axis 32 and second axis 36 extend perpendicular to each other e.g. the first axis 32 may extend horizontally and the second axis vertically, or vice versa.

Thus, in the illustrated embodiment, the categories are rotated vertically along the horizontal axis 32, with the list items then being rotated horizontally along the vertical axes 36.

In an embodiment, the three-dimensional portal body 12 and/or one or more of the three-dimensional body components 34 may be rotated multi-directionally e.g. either clockwise or anti-clockwise.

In an embodiment, each selectable list item 28 is either active, wherein the user can select the list item so as to trigger an external event, or passive, wherein the data element does not trigger an external event.

In an embodiment, and in respect of active list items, the invention allows the user 16, through the user input means 21, to select any of the active list items 28, with each active list item 28 either having a corresponding resource location that resides on either the remote server 24 or an external server, in which case the remote server 24 serves as a link between the user and the external server. In this embodiment, in response to the user selecting an active list item 28, the user 16 is redirected to the associated resource location.

Alternatively, the selection of an active list item 28 triggers an application on the user device 14, such as playing a video, a game, or a music track.

In an embodiment, and in respect of passive list items, the passive list items comprise data, including, but not limited to, images, text or other static information.

In an embodiment, the list items and/or list categories are stored offline or on a remote server.

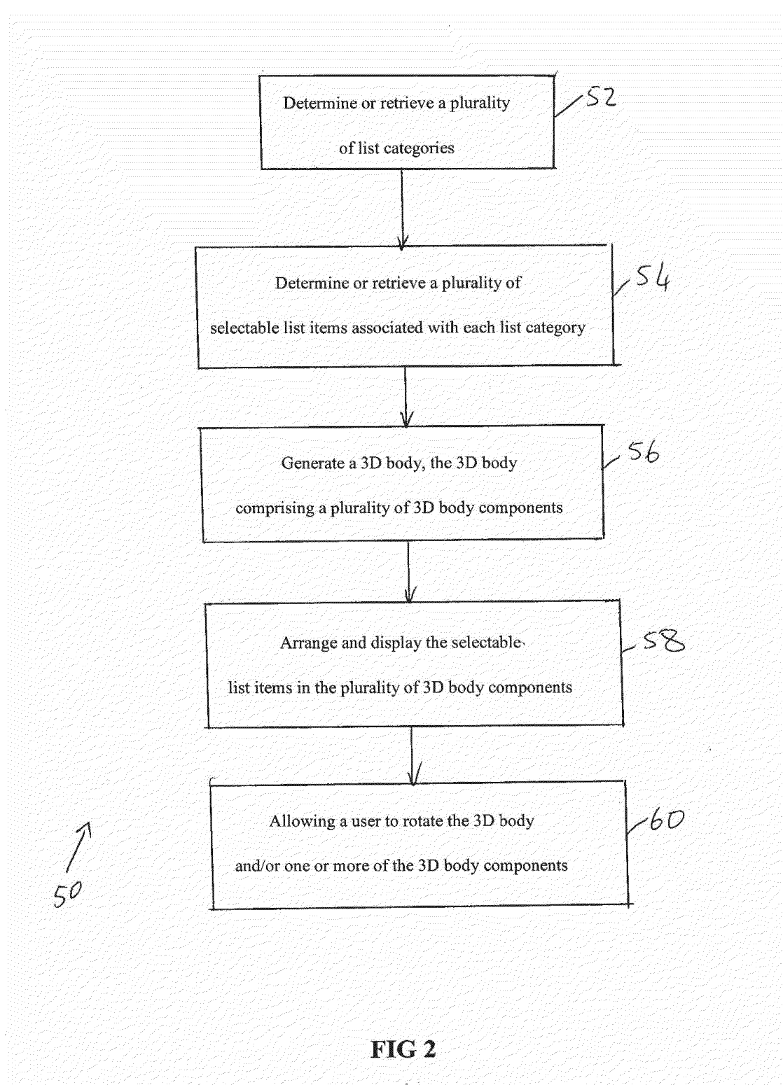

Turning now to FIG. 2, a method 50 of generating and populating a three-dimensional rotatable user interaction portal, according to a further aspect of the present invention, will now be described in more detail. The method 50 comprises the step of determining or retrieving a plurality of list categories as indicated by block 52.

The method 50 further comprises the step of determining or retrieving a plurality of selectable list items associated with each list category, as indicated by block 54.

The method further 50 comprises the step of generating a three-dimensional body that can rotate about a first axis, the three-dimensional body in turn comprising a plurality of three-dimensional body components, each body component being rotatable about a second axis, as indicated by block 56.

The method 50 further comprises the step of arranging and displaying the selectable list items in the plurality of three-dimensional body components, as indicated by block 58.

The method further 50 comprises the step of allowing a user, through a user input means, to rotate the three-dimensional body and/or one or more of the three-dimensional body components, along a defined path provided by the first and/or second axis, respectively, as indicated by block 60.

1. A method of generating and populating a three-dimensional rotatable user interaction portal comprising the steps of;
determining or retrieving a plurality of list categories;
determining or retrieving a plurality of selectable list items associated with each list category;
generating a three-dimensional body that can rotate about a first axis, the three-dimensional body in turn comprising a plurality of three-dimensional body components, each body component being rotatable about a second axis;
arranging and displaying the selectable list items in the plurality of three-dimensional body components; and
allowing a user, through a user input means, to rotate the three-dimensional body and/or one or more of the three-dimensional body components, along a defined path provided by the first and/or second axis, respectively.

2. The method of claim 1, wherein each list category is associated with one of the three-dimensional body components, with the category being optionally displayed proximate the relevant body component.

3. The method of claim 1, wherein each of the three-dimensional body components comprises a plurality of selectable list items that may be selected by the user.

4. The method of claim 1, wherein the first and second axes extend perpendicular to each other e.g. the first axis may extend horizontally and the second axis vertically, or vice versa.

5. The method of claim 1, wherein the three-dimensional body and/or one or more of the three-dimensional body components may be rotated multi-directionally.

6. The method of claim 1, wherein each selectable list item is either active, wherein the user can select the list item so as to trigger an external event, or passive, wherein the data element does not trigger an external event.

7. The method of claim 6, wherein in respect of active list items, the method comprises the steps of allowing a user, through the user input means, to select any of the active list items, with each active list item either having a corresponding resource location that resides on either the remote server or an external server, in which case the remote server serves as a link between the user and the external server.

8. The method of claim 6, wherein the selection of an active list item triggers an application on a user device, such as playing a video, a game, or a music track.

9. The method of claim 6, wherein in respect of passive list items, the passive list items comprise data, including, but not limited to, images, text or other static information.

10. The method of claim 1, wherein the list items and/or list categories are stored offline or on a remote server.

11. A system for generating and populating a three-dimensional rotatable user interaction portal comprising a processor that is arranged to;
determine or retrieving a plurality of list categories;
determine or retrieving a plurality of selectable list items associated with each list category;
generate a three-dimensional body that can rotate about a first axis, the three-dimensional body in turn comprising a plurality of three-dimensional body components, each body component being rotatable about a second axis;
arrange and displaying the selectable list items in the plurality of three-dimensional body components; and
allow a user, through a user input means, to rotate the three-dimensional body and/or one or more of the three-dimensional body components, along a defined path provided by the first and/or second axis, respectively.

12. A non-transitory computer readable medium having stored thereon a set of computer readable instructions for causing a processor to generate and populate a three-dimensional rotatable user interaction portal comprising the computer implemented steps of;
determining or retrieving a plurality of list categories;
determining or retrieving a plurality of selectable list items associated with each list category;
generating a three-dimensional body that can rotate about a first axis, the three-dimensional body in turn comprising a plurality of three-dimensional body components, each body component being rotatable about a second axis;
arranging and displaying the selectable list items in the plurality of three-dimensional body components; and
allowing a user, through a user input means, to rotate the three-dimensional body and/or one or more of the three-dimensional body components, along a defined path provided by the first and/or second axis, respectively.

13. A system for generating and populating a three-dimensional rotatable user interaction portal, the system comprising;
a user device associated with a user, the user device comprising a processor, a display and user input means; and
a server remote from the user device but in communication with the user device, the server comprising storage means to store selectable list items, the remote server being arranged to send list items to the user device for display on the user device display,
wherein the user processor of the user device is arranged to:
generate a three-dimensional body that can rotate about a first axis, the three-dimensional body in turn comprising a plurality of three-dimensional body components, each body component being rotatable about a second axis;
arrange and displaying the selectable list items in the plurality of three-dimensional body components; and
allow a user, through a user input means, to rotate the three-dimensional body and/or one or more of the three-dimensional body components, along a defined path provided by the first and/or second axis, respectively.
